(19) United States
(12) Patent Application Publication
(10) Pub. No.: US 2005/0136735 A1
(43) Pub. Date: Jun. 23, 2005

(54) Coaxial connector having improved locking sleeve

(75) Inventors: Julio F. Rodrigues, Collierville, TN (US); Andrew Barger, Collierville, TN (US)

Correspondence Address: G. Andrew Barger;Thomas & Betts Corporation, 8155 T&B Boulevard, 4B-36, Memphis, TN, 38125, US

(73) Assignee: Thomas & Betts International, Inc.

(21) Appl. No.: 10/738,387

(22) Filed: Dec. 17, 2003

(51) Int. Cl. H01R 9/05

(52) U.S. Cl. 439/578

(57) ABSTRACT

A connector is provided for terminating coaxial cable. The connector includes a connector body having an annular detent disposed therein and a locking sleeve detachably coupled to the connector body and having a plurality of evenly spaced protrusions formed thereon. The plurality of evenly spaced protrusions are received in the detent when the coaxial cable is terminated in the connector.

### FIELD OF THE INVENTION

The present invention relates generally to connectors for terminating coaxial cable. More particularly, the present invention relates to a connector having a locking sleeve that requires decreased insertion force to terminate a coaxial cable to a connector body.

### BACKGROUND OF THE INVENTION

It has long been known to use connectors to terminate coaxial cable so as to connect a cable to various electronic devices such as televisions, radios and the like.

Conventional coaxial cables typically include a center conductor surrounded by an insulator. A braided or foil conductive shield is disposed over the insulator. An outer insulative jacket surrounds the shield. In order to prepare the coaxial cable for termination, the outer jacket is stripped back exposing an extent of the conductive shield which is folded back over the jacket. A portion of the insulator extends outwardly from the jacket and an extent of the center conductor extends outwardly from insulator. Such a prepared cable may be terminated in a conventional coaxial connector.

Coaxial connectors of this type include a connector body having an inner cylindrical post that is inserted between the insulator and the conductive shield. A locking sleeve is provided to secure the cable within the body of the coaxial connector. The locking sleeve, which is typically formed of a resilient plastic, is securable to the connector body to affix the coaxial connector thereto. A leading coaxial connector of this type is shown and described in U.S. Pat. No. 6,530,807 that is assigned to Thomas & Betts Corporation (headquartered at 8155 T&B Blvd, Memphis, Tenn. 38125, U.S.A.) and entitled: “Coaxial connector having detachable locking sleeve.”

Coaxial connectors of this type employ a uniform annular ring that is integrally formed on the outside of the locking sleeve for detachably locking the sleeve to the connector body once a coaxial cable is inserted therethrough. Since the annular ring is slightly larger than the collar of the connector body, compression force must be used to insert the locking sleeve and cable into the collar of the connector body. During insertion, the collar compresses the ring's diameter because the collar is of a harder material than the locking sleeve. Once the uniform annular ring is seated within the collar, its diameter expands back to its original size and form, thereby locking the sleeve to the collar. Since the ring spans 360° around the outside of the locking sleeve, it requires sufficient force, which is typically applied by a tool, to terminate a cable in the connector by inserting the locking sleeve within the connector body.

It is therefore desirable to provide an improved coaxial connector having an improved locking sleeve that decreases the compression force required for insertion of the sleeve into the connector body while suffering no loss in locking capabilities, structural integrity, RFI performance, or water loss migration. It is further desirable to reduce stresses applied to the locking sleeve during insertion into and removal from the connector body.

### SUMMARY OF THE INVENTION

The present invention eliminates the above difficulties and disadvantages by providing a coaxial connector having a locking sleeve with low compression force for inserting into the connector body. In particular, the present locking sleeve includes at least one protrusion, but preferably a plurality of protrusions formed on the locking sleeve, which are spaced about the locking sleeve and preferably evenly spaced. The connector includes a connector body having an annular detent disposed therein and a locking sleeve detachably coupled to the connector body. The protrusions are received in the detent, which is preferably annular, when the coaxial cable is terminated in the connector while suffering no loss in locking capabilities, structural integrity, RFI performance, or water loss migration. The protrusions include a chamfered front wall for easing insertion into the detent, which has a complementary and chamfered wall for receiving the front wall of the protrusions. The protrusions also include a perpendicular rear wall and the detent includes a forwardly facing perpendicular wall for abutting the perpendicular rear wall of the protrusions and preventing extraction of the protrusions from the detent. In addition, the protrusions are of greater malleable composition than the connector body and preferably constructed of plastic with the connector body being formed of metal.

### BRIEF DESCRIPTION OF THE DRAWINGS

FIG. 1 is an exploded perspective view showing of the coaxial connector of the present invention including a connector body and a detachably coupled locking sleeve.

FIG. 2 is a perspective view of the coaxial connector of the present invention including the connector body and the detachably coupled locking sleeve of FIG. 1.

FIG. 3 is a cross-sectional view of the coaxial connector of the present invention including the connector body and the detachably coupled locking sleeve of FIG. 1.

FIG. 4 is an exploded cross-sectional view of the coaxial connector of the present invention including a connector body and a detachably coupled locking sleeve of FIG. 1 showing a coaxial cable being inserted into the connector.

FIG. 5 is a partial cross-sectional view of the locking sleeve inserted into the coaxial connector of the present invention.

### DETAILED DESCRIPTION OF THE PREFERRED EMBODIMENTS

The present invention is directed to connectors for terminating coaxial cable. Coaxial connectors of this type are shown and described in U.S. Pat. No. 6,530,807 issued Mar. 11, 2003, which is incorporated by reference herein for all purposes.

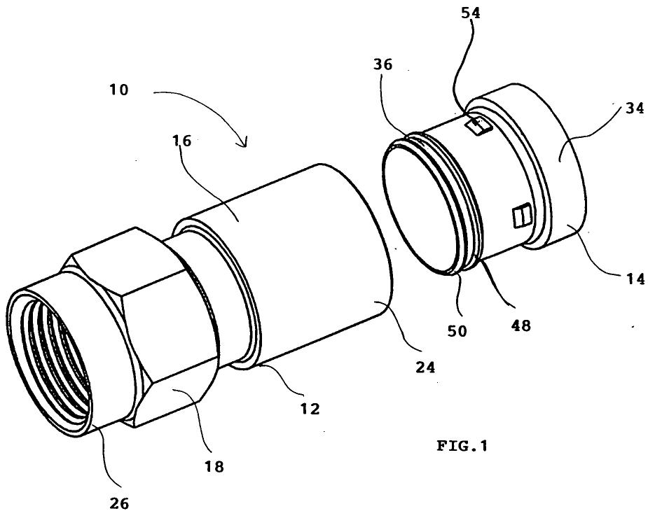

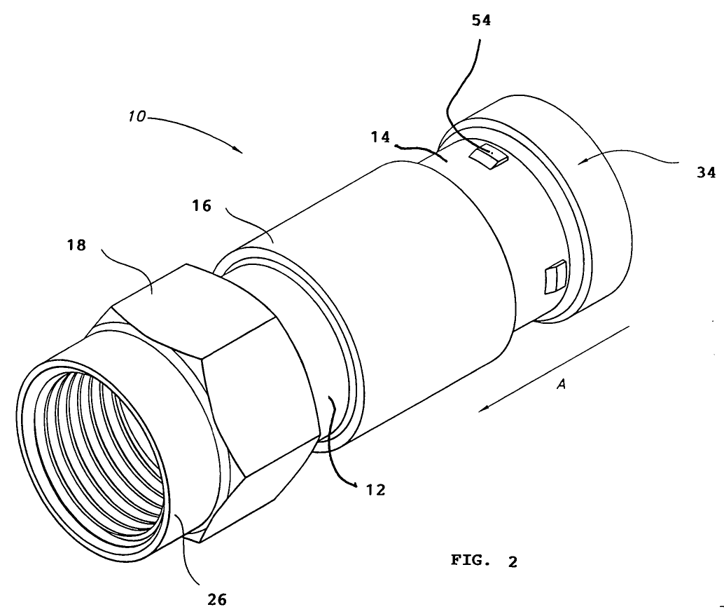

Referring first to FIGS. 1-3, the coaxial cable connector 10 of the present invention is shown. Connector 10 includes two major components, a connector body 12 and a locking sleeve 14 attachably coupled to body 12. Body 12 is an elongate generally cylindrical conductive member typically formed of metal, preferably brass. Body 12 includes an annular collar 16 for accommodating a coaxial cable, an annular nut 18 rotatably coupled to collar 16 for providing mechanical attachment of the connector to an external device. Interposed between collar 16 and nut 18 is an annular post 20. A resilient sealing O-ring 22 may be positioned between collar 16 and nut 18 at the rotatable juncture thereof to provide a seal thereat. Nut 18 includes an internally threaded end extent 26 permitting screw threaded attachment of body 12 to the external device. Annular post 20 includes a base portion 28 which provides for securement of post 20 between nut 18 and collar 16 and an annular tubular extension 30 extending into collar 18. As will be described in further detail hereinbelow and as is conventionally known, the extension 30 of post 20 and the collar 16 define an annular chamber 32 for accommodating the jacket and shield of the inserted coaxial cable.

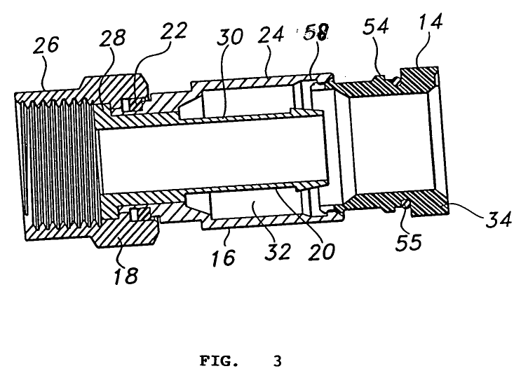

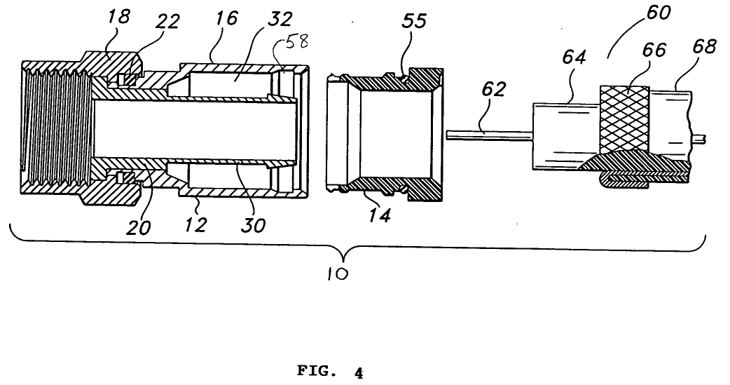

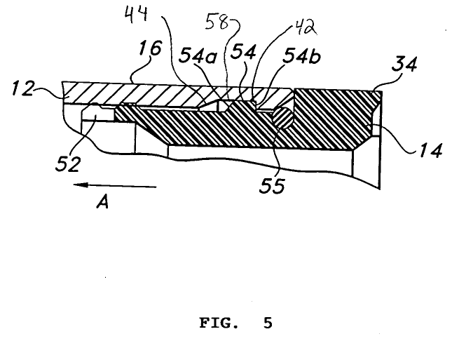

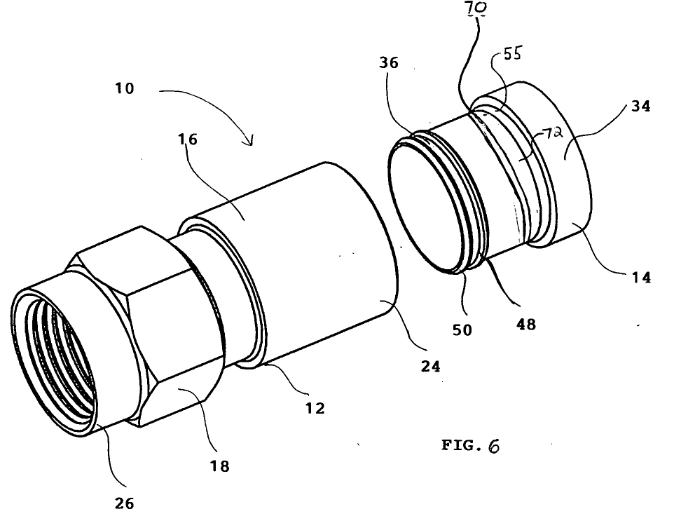

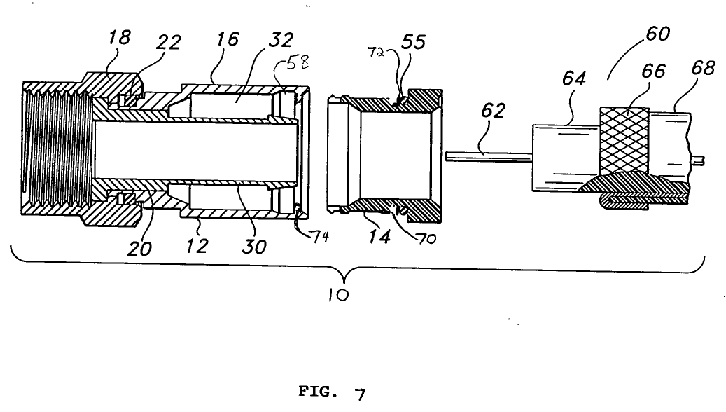

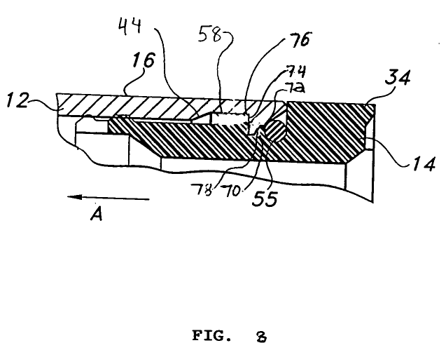

Locking sleeve 14 is a generally cylindrical member formed of resilient material preferably a synthetic plastic such as an acetate resin. Locking sleeve 14 includes a flared rearward end 34 through which a cable may be inserted. Opposite rearward end 34 is a forward end 36 which is insertable into locking sleeve 14. As will be described in further detail hereinbelow, the forward end 36 of locking sleeve 14 includes cooperative detent structure which allows for the detachable, re-attachable connection of locking sleeve 14 to body 12. Furthermore, connector 10 is designed such that locking sleeve 14 is axially moveable along arrow A of FIG. 2, towards nut 18 from a first position shown in FIG. 2, which loosely retains the cable within connector body 12 through an intermediate position, to a more forward second position shown in FIG. 5, which secures the cable within connector body 12.

Connector 10 of the present invention is constructed so as to be supplied in the assembled condition shown in FIG. 3. In such assembled condition, and as will be described in further detail hereinbelow, a coaxial cable may be inserted through the rearward end 34 of locking sleeve 14 and through connector body 12. The locking sleeve may be moved from the first position loosely retaining the cable to the second position which is axially forward thereby locking the cable to the connector body. It is, however, contemplated that the locking sleeve 14 may be detached from connector body 12 and in a manner which will be described in further detail hereinbelow, so as to allow the coaxial cable to be inserted directly into receiving end 24 of connector body 12. Thereafter, the locking sleeve 14 which has been placed around the cable may be reattached to receiving end 24 of body 12 where it can be moved from the first position to the second position locking the cable to the connector body.

The cooperating detent structure mentioned above, is employed to provide such detachment and reattachment of locking sleeve 14 to connector body 12. The cooperating detent structure of the present invention further includes the forward end 36 of locking sleeve 14. As may be appreciated, the forward end 36 of locking sleeve 14 may be inserted into the receiving end 24 of collar 16. This defines the first position of locking sleeve 14. While the locking sleeve is accommodated in collar 16 it may be detachable and such removal is facilitated by the resiliency of the plastic material forming locking sleeve 14 and relative thickness of the sleeve wall thereat. In particular, the protrusions 54 of the locking sleeve 14 are of greater malleable composition, as well as the locking sleeve 14, than the connector body 12, which is preferably constructed of metal such as brass with the protrusions 14 being formed of plastic along with the locking sleeve 14. In an alternate embodiment, however, the connector body 12 and locking sleeve are both formed of the same material with only the protrusions 54 being of a material such as plastic or rubber that is of greater malleable composition than the connector body 12. In this regard, connector body 12 can also be constructed of plastic, and preferably a thermoformed plastic such as acetate resin.

As shown in FIGS. 1-5, the cooperative detent structure includes at least one radially outwardly extending protrusion 54 adjacent rearward end 34 of sleeve 14, but preferably a plurality of protrusions 54 as will be discussed in greater detail below. The protrusions 54 allow the locking sleeve 14 to be inserted into the connector body 12 with low compression force to terminate cable 60 within connector body 12 while the connector 10 suffers no loss in locking capabilities, structural integrity, RFI performance, or water loss migration. In particular, the present locking sleeve includes at least one protrusion 54, but preferably a plurality of protrusions 54 formed on the locking sleeve 14, which are spaced about the locking sleeve 14 and preferably evenly spaced around the outer circumference. The protrusions 54 are received in detent 58, which is preferably annular, when the coaxial cable 60 is terminated in the connector 10. Upon continued coaxial movement along arrow A, as shown in FIGS. 2 and 5, protrusions 54 engage detent 58 that locks cable 60 to connector body 12 in the second position as shown in FIG. 5. Since detent 58 is uniform and preferably annular, it does not matter how the protrusions 54 are oriented in a circumferential direction when locking sleeve 14 is inserted into the second position within the connector body 12.

As further shown in FIG. 5, each of the protrusions 54 include a chamfered front wall 54a, which is preferably formed at a forty-five degree angle, for easing insertion into detent 58, which has a complementary and chamfered wall 44 for receiving the front wall 54a of the protrusions 54. The protrusions 54 also include a perpendicular rear wall 54b and detent 58 includes a forwardly facing perpendicular wall 42 for abutting the perpendicular rear wall 54b of the protrusions 54 and preventing extraction of the protrusions from detent 58.

Referring now to FIGS. 6-8, an alternate embodiment of the present invention is shown. In this embodiment the locking sleeve 14 is coupled to the connector body 12 and has at least one groove 70 formed therein, which is preferably U-shaped. The groove 70 is preferably continuous, but can also be annularly spaced apart apertures. An O-ring 55, preferably made of resilient rubber, is disposed about the locking sleeve 14 for sealing the locking sleeve 14 to the connector body 12 when the locking sleeve 14 is in the second position. Between the O-ring 55 and groove 70 is disposed a retention wall 72 for keeping the O-ring 55 in place when the locking sleeve 14 is moved to the second position.

In this embodiment projection 74 is annular and frictionally slides along the smooth outer wall of locking sleeve 14 is received into groove 70 when the locking sleeve 14 is inserted into the connector body 12, as shown in FIG. 8, and the cable 60 is terminated therein. An important advantage of this embodiment is that there is no protrusion or rib disposed on the outer surface of locking sleeve 14 that must be compressed by projection 74 when the locking sleeve 14 is secured to the connector body 12, which further reduces the axial compression forced needed to be applied to the locking sleeve 14 by an installer.

Projection 74 is preferably constructed of metal, such as brass, and integrally formed within connector body 12, but can also be constructed of plastic. It can further be constructed of rubber and employed as an O-ring. The frictional engagement of projection 74 against the outer surface of the locking sleeve 14 is slight and instead of the projection having to compress the locking sleeve 14 at the points where the protrusions 54 are annularly disposed in the prior embodiment discussed above, projection 74 is received into groove 70 and minimal inward compression of locking sleeve 14 is required.

Once in the second position, projection 74 is received in groove 70, securing the locking sleeve to the connector body 12 in the following fashion. Projection 74 includes a perpendicular wall 42 and a chamfered wall 78 opposite perpendicular wall 76. At this time O-ring 55 is compressed among the flared rearward end 34 of the locking sleeve 14, the projection 74 and the retention wall 72 when the locking sleeve 14 is moved to the second position. The perpendicular wall 76 prevents removal of the locking sleeve 14 from the connector body 12 when in the second position.

Having described the components of connector 10 in detail, the use of connector 10 in terminating a coaxial cable may now be described with respect to FIG. 4. Coaxial cable 60 includes an elongate inner conductor 62 formed of copper or similar conductive material. Extending around inner conductor 62 is a conductor insulator 64 formed of a suitably insulative plastic. A metallic shield 66 is positioned in surrounding relationship around insulator 64. Shield 66 is a metallic braid, however, other conductive materials such as metallic foil may also be employed. Covering shield 66 is an outer insulative jacket 68.

Cable 60 is prepared in conventional fashion for termination, by stripping back jacket 68 exposing an extent of shield 66. A portion of insulator 64 extends therefrom with an extent of conductor 62 extending from insulator 64. The preparation process includes folding back an end extent of shield 66 about jacket 68.

Cable 60 may be inserted into connector 10 with the locking sleeve 14 coupled to collar 16 of body 12 as shown in FIGS. 2 and 3. In this technique, the prepared cable 60 is inserted through rearward end 34 of sleeve 14 and into the receiving end 24 of collar 16. Extension 30 of post 20 of body 12 is inserted between the insulator 64 in the metallic shield 66 such that the shield and the jacket 68 reside within the annular region 32 defined between post 20 and collar 16. In this position, the locking sleeve is coupled to collar 16 in the first position shown in FIGS. 2 and 3. In such first position, sufficient clearance is provided between sleeve 14 and collar 16 so that extension 30 may easily be interposed between insulator 64 and shield 66.

Once the cable 60 is properly inserted, the locking sleeve 14 may be moved from the first position shown in FIG. 4, to an intermediate position shown in FIG. 5, where the locking sleeve is moved axially forward. Such movement is facilitated by the chamfered wall 44 of receiving end 24 of collar 16. In this second position, jacket 68 and shield 66 of cable 60 begins to become compressively clamped within annular region 32 between post 20 and collar 16. The sleeve 14 is further axially advanced along arrow A from the intermediate position to a second position shown in FIG. 5. Such second position is achieved as protrusions 54 are disposed within detent 58 of collar 16. In that regard and discussed in further detail above, protrusions 54 have a forwardly chamfered front wall 54a for engagement with chamfered wall 44 of detent 58 to facilitate such resilient movement. Further, the rear wall 54b of protrusions 54 is perpendicular so as to engage perpendicular wall 42 of detent 58 to maintain sleeve 14 in the second position with respect to collar 16. A suitable tool may be used to effect movement of locking sleeve 14 from its first position to its second position securing cable 60 to connector body 12.

It is contemplated that the engagement between insulative jacket 68 and the connector body 12 establishes a sealed engagement thereat. In order to further facilitate the seal, locking sleeve 14 may optionally support a sealing O-ring 55 which provides a seal with the chamfered wall 44 of collar 16 in the second position.

Proper insertion of cable 60 into connector body 12 requires that the cable be inserted in such a manner that the extension 30 of post 20 becomes resident between insulator 64 and shield 66. In certain installation settings, the installer may not have clear and convenient access when terminating cable 60. Moreover, insertion may be rendered difficult by poor cable preparation, which may result in a frayed end. Therefore, it may be difficult for the installer to blindly insert the cable 60 through the locking sleeve 14 and into connector body 12. In such situations, the present invention contemplates the ability to detachably remove locking sleeve 14 from connector body 12 so that the cable may be directly inserted to receiving end 24 of collar 16. In these situations, locking sleeve 14 is detachably removed from collar 16 in a manner facilitated as above described. The locking sleeve 14 is then slipped over cable 60 and moved to a convenient position along the cable length. The end of cable 60 may then be inserted directly into the rearward end 34 of collar 16 to easily assure that extension 30 of post 20 is inserted between insulator 64 and shield 66. Thereafter, the locking sleeve 14 may be brought up along the cable and the forward end 36 of locking sleeve 14 may be inserted into the rearward end 34 of collar 16. Thereafter, as described above, the locking sleeve may be moved from the first position shown in FIG. 2 to a second position shown in FIG. 5 where the protrusions 54 become resident forward of perpendicular wall 42 thereby locking cable 60 in connector body 12.

Various changes to the foregoing described and shown structures will now be evident to those skilled in the art. Accordingly, the particularly disclosed scope of the invention is set forth in the following claims.

1. A connector for terminating a coaxial cable comprising:
a connector body having a detent disposed therein; and
a locking sleeve coupled to the connector body and having at least one protrusion formed thereon partially encircling the locking sleeve and for being received in the detent when the coaxial cable is terminated in the connector.

2. The connector of claim 1 wherein the locking sleeve is detachably coupled to the connector body.

3. The connector of claim 2 wherein the locking sleeve is movable from a first position loosely retaining said cable in the connector body to a second position locking said cable to the connector body.

4. The connector of claim 1 wherein the detent is annular.

5. The connector of claim 4 wherein the locking sleeve includes a plurality of protrusions formed thereon and being evenly spaced about the locking sleeve.

6. The connector of claim 1 wherein the at least one protrusion includes a chamfered front wall for easing insertion into the detent.

7. The connector of claim 6 wherein the detent includes a rearwardly facing chamfered wall that is complementary to the chamfered front wall of the at least one protrusion.

8. The connector of claim 7 wherein the at least one protrusion is of greater malleable composition than the connector body.

9. The connector of claim 1 wherein the at least one protrusion includes a perpendicular rear wall.

10. The connector of claim 9 wherein the detent includes a forwardly facing perpendicular wall for abutting the perpendicular rear wall of the at least one protrusion and preventing extraction of the at least one protrusion from the detent.

11. A connector for terminating a coaxial cable comprising:
a connector body having an annular detent disposed therein; and
a locking sleeve detachably coupled to the connector body having a plurality of evenly spaced protrusions formed thereon and for being received in the detent when the coaxial cable is terminated in the connector.

12. The connector of claim 11 wherein the at least one protrusion includes a chamfered front wall for easing insertion into the detent.

13. The connector of claim 12 wherein the detent includes a rearwardly facing chamfered wall that is complementary to the chamfered front wall of the at least one protrusion.

14. The connector of claim 11 wherein the at least one protrusion includes a perpendicular rear wall.

15. The connector of claim 14 wherein the detent includes a forwardly facing perpendicular wall for abutting the perpendicular rear wall of the at least one protrusion and preventing extraction of the at least one protrusion from the detent.

16. The connector of claim 11 wherein the at least one protrusion is of greater malleable composition than the connector body.

17. A connector for terminating a coaxial cable comprising:
a connector body having a cable receiving end and a projection disposed therein;
a locking sleeve coupled to the connector body and having a rearward end, a smooth annular portion and at least one groove formed between the rearward end and the smooth annular portion; and
wherein the projection slides along the smooth annular portion and is subsequently received in the groove when the coaxial cable is terminated in the connector body.

18. The connector of claim 17 wherein the locking sleeve has a first position and a second position.

19. The connector of claim 18 wherein the projection slides along the smooth annular portion and is subsequently received in the groove when the locking sleeve is moved to the second position for securing the locking sleeve to the connector body.

20. The connector of claim 17 wherein the projection is an O-ring.
